SEQUENCE LISTING (2 sequences)

SEQ ID NO: 1 - DNA, 19 bp, Artificial Sequence
  515F Primer
gtgccagcmgccgcggtaa

SEQ ID NO: 2 - DNA, 20 bp, Artificial Sequence
  806R Primer
ggactacvsgggtatctaat

(19) United States
(12) Patent Application Publication
(10) Pub. No.: US 2024/0225048 A1
(43) Pub. Date: Jul. 11, 2024

(54) Pet Food Composition

(71) Applicant: Blue Buffalo Enterprises, Inc., Wilton, CT (US)

(72) Inventors: Nolan Frantz, Allen, KS (US); Matthew Panasevich, McKinney, TX (US)

(73) Assignee: Blue Buffalo Enterprises, Inc., Wilton, CT (US)

(21) Appl. No.: 18/289,157

(22) PCT Filed: May 19, 2022
(86) PCT No.: PCT/US2022/029952

§ 371 Date: Nov. 1, 2023

Related U.S. Application Data
(60) Provisional application No. 63/191,008, filed on May 20, 2021.

(51) Int. Cl. A23K 10/16; A23K 10/30; A23K 10/37; A23K 20/163; A23K 50/42

(52) U.S. Cl. CPC A23K 10/16; A23K 10/30; A23K 10/37; A23K 20/163; A23K 50/42; A23V 2400/113

(57) ABSTRACT

Described is a pet food composition that combines a fermentate that contains a non-viable, non-pathogenic bacteria and a prebiotic that contains an oligosaccharide component to achieve a gut health benefit in a companion animal.

### SEQUENCE LISTING

The instant application contains a Sequence Listing which has been submitted electronically in ASCII format and is hereby incorporated by reference in its entirety. Said ASCII copy, created on 19 May 2022, is named 8894WO01_ST25.txt and is 589 bytes in size.

### BACKGROUND

Consumers are increasingly treating their pets like family members. As consumers embrace their pets as family members, products that help them manage their pets' health as family members are needed.

### SUMMARY

The present disclosure relates to a pet food composition formulated to improve pet gut health.

A pet food composition is provided herein that includes a fermentate and a prebiotic. The fermentate is included in the pet food composition in an amount of about 0.1% to about 1% by weight on a dry matter basis of the pet food composition, where the fermentate includes peptidoglycan from a non-viable, non-pathogenic gram-positive bacteria in an amount of at least 80% by dry weight of the fermentate. The prebiotic includes an oligosaccharide component, where the oligosaccharide component is included in an amount of about 0.5% to 2% by weight on a dry matter basis of the pet food composition, and the oligosaccharide component includes alginate oligosaccharide (AOS), mannan-oligosaccharides (MOS), fructooligosaccharides (FOS), or any combination thereof.

In some embodiments, the non-pathogenic gram-positive bacteria can include a probiotic bacteria. In some embodiments, the probiotic bacteria can include Lactobacillus acidophilus.

In some embodiments, the fermentate can be included in an amount of about 0.2% to about 0.7% by weight on a dry matter basis of the pet food composition.

In some embodiments, the fermentate can include from about 85% to about 95% by weight peptidoglycan from a non-viable gram-positive probiotic bacteria.

In some embodiments, the oligosaccharide component can include AOS, where at least a portion of the AOS is contributed by kelp. In some embodiments, kelp can be included in an amount of about 0.2% to about 1% by weight on a dry matter basis of the pet food composition.

In some embodiments, the oligosaccharide component can include MOS in an amount of about 0.1% to about 0.5% by weight on a dry matter basis of the pet food composition.

In some embodiments, the oligosaccharide component can include FOS in an amount of about 0.1% to about 0.5% by weight on a dry matter basis of the pet food composition.

In some embodiments, the prebiotic can include a beet pulp in an amount of about 1% to about 8% by weight on a dry matter basis of the pet food composition.

In some embodiments, the prebiotic can include inulin in an amount of about 0.1% to about 0.5% by weight on a dry matter basis of the pet food composition.

In some embodiments, the prebiotic contributes soluble fiber in an amount of about 0.5% to about 5% by weight on a dry matter basis of the pet food composition.

In some embodiments, the pet food composition can be a dry kibble having a moisture content of less than 12% by weight of the pet food composition.

In some embodiments, the pet food composition can be formulated for a dog or a cat.

In some embodiments, a pet food composition can include a fermentate in an amount of 0.2% to 0.7% by weight on a dry matter basis of the pet food composition, where the fermentate includes peptidoglycan from a non-viable Lactobacillus acidophilus in an amount of 85% to 95% by weight of the fermentate; and a prebiotic including kelp in an amount of 0.2% to 1% by weight on a dry matter basis of the pet food composition.

In some embodiments, the prebiotic can include beet pulp in an amount of 1% to 8% by weight on a dry matter basis of the pet food composition.

In some embodiments, the prebiotic can include an oligosaccharide component in an amount of about 0.5% to 2% by weight on a dry matter basis of the pet food composition, where the oligosaccharide component includes alginate oligosaccharide (AOS), mannan-oligosaccharides (MOS), fructooligosaccharides (FOS), or any combination thereof.

In some embodiments, the prebiotic can include MOS in an amount of 0.1% to 0.5% by weight on a dry matter basis of the pet food composition, FOS in an amount of 0.1% to 0.5% by weight on a dry matter basis, and inulin in an amount of 0.1% to 0.5% by weight on a dry matter basis of the pet food composition.

In some embodiments, the prebiotic can contribute soluble fiber in an amount of about 0.5% to about 5% by weight on a dry matter basis of the pet food composition.

These and various other features and advantages will be apparent from a reading of the following detailed description.

### DETAILED DESCRIPTION

Consumers are increasingly embracing the role pets play in their families. Such consumers, sometimes referred to as “pet parents,” look for ways to meet the needs of their pets while also treating them as though they are a full member of their family, including their overall health and wellbeing. Pet parents are increasingly looking to pet foods to meet more than just the nutritional needs of their pets, but also support overall health of their pets.

It was surprisingly discovered, and is disclosed herein, that a pet food composition formulated to incorporate a prebiotic that includes an alginate oligosaccharide (AOS) and a fermentate containing peptidoglycan from a non-viable, non-pathogenic gram-positive bacteria has a synergistic positive effect on several gut health indicators, and an additive effect on several others. Particularly surprising is that a pet food composition described herein can increase the presence of fecal metabolites that are positive indicators of gut health. That is, the combination of a particular probiotic and non-viable bacteria in a pet food composition described herein provides a synergistic positive effect on pet gut health indicators, especially fecal metabolites, despite no known metabolic interdependence between non-viable bacteria and prebiotics since prebiotics provide an energy source for viable bacteria, but non-viable bacteria have no use for them.

A pet food composition provided herein can provide a benefit of improving one or more gut health indictor in a pet without having to maintain viability of a probiotic over shelf life, especially in a dry pet food. In addition, a pet food provided herein can be made using standard pet food manufacturing techniques, such as high temperature processing (e.g., extrusion, retort, and the like), without losing a gut health benefit.

A pet food composition provided herein includes ingredients that are combined using pet food manufacturing techniques to achieve a pet food composition having a desired nutritional content and moisture content. A pet food composition provided herein can be in any suitable commercial form, such as a shelf-stable dry kibble, a wet shelf-stable food (e.g., in a can or a pouch), a fresh refrigerated or frozen food, pet treats, or the like.

A pet food composition provided herein includes a fermentate in an amount of about 0.1% to about 1% (e.g., about 0.2% to about 0.7%) by weight on a dry matter basis in the pet food composition. As used herein, a fermentate includes peptidoglycan (PG) from a non-viable, non-pathogenic bacteria in an amount of at least 80% (e.g., about 85% to about 95%, or about 90%) by dry weight of the fermentate. PG in a fermentate can be present as cell walls of whole, non-viable bacteria, fragments of such cell walls, or a combination thereof. A fermentate can include components other than PG, such as other bacterial components, byproducts of a fermentation process, and/or components from bacterial growth medium.

Preferably, PG in a fermentate is from a non-viable, non-pathogenic gram-positive bacteria. Probiotic bacteria PG is particularly useful in a fermentate included in a pet food herein, and can include PG from one or a combination of probiotic strains of bacteria from the genera Lactobacillus (e.g., L. acidophilus, L. plantarum, L. delbrueckii subsp. bulgaricus, and the like), Bifidobacterium (e.g., B. bifidum, B. animalis subsp. lactis, and the like), Lactococcus (e.g., L. lactis subsp. lactis), Enterococcus (e.g., E. durans, certain strains of E. faeceium, and the like), Streptococcus (e.g., S. thermophilus), Pediococcus, Leuconostoc, Bacillus (e.g., B. subtilis, B. coagulans, and the like), any combinations thereof, and the like.

A fermentate can be made using any appropriate method of rendering bacteria non-viable, including heat treatment, physical cell wall disruption, irradiation, and the like, or any combination thereof. Preferably, non-viable bacteria included in a fermentate are dead. In some embodiments, bacteria are concentrated and/or purified before or after rendering them non-viable to make a fermentate. In some embodiments, a fermentate is made from a biproduct of a fermentation process, such as cheese or yogurt making.

Commercially available fermentates include those under the brand Culbac® (TransAgra International, Inc., Storm Lake, IA, USA), which is a fermentate containing about 90% by dry weight PG from a proprietary L. acidophilus strain, and those included in human supplements sold under the brand name Viactiv®, which include a Lactobacillus LB™ fermentate.

A pet food composition provided herein also comprises a prebiotic that includes an oligosaccharide component. An oligosaccharide component can include one or more of alginate oligosaccharide (AOS), mannan-oligosaccharides (MOS), and fructooligosaccharides (FOS). In some embodiments, an oligosaccharide component can be included in an amount of about 0.5% to about 2% (e.g., about 0.75% to about 1.5%) by weight on a dry matter basis in a pet food composition.

In some embodiments, a brown algae ingredient (e.g., kelp) can be used to contribute AOS to a pet food composition provided herein. In some embodiments, a brown algae ingredient, such as kelp, can be included in a pet food composition provided herein in an amount of about 0.2% to about 1% (e.g., about 0.3% to about 0.8%) by weight on a dry matter basis in the pet food composition.

In some embodiments, MOS can be included in an amount of from about 0.1% to about 0.5% (e.g., about 0.15 to about 0.35%) by weight on a dry matter basis in a pet food composition. In some embodiments, FOS can be included in an amount of from about 0.1% to about 0.5% (e.g., about 0.15 to about 0.35%) by weight on a dry matter basis in a pet food composition.

In some embodiments, a prebiotic can contain one or more additional soluble fiber, such as fiber from beet pulp, inulin, and the like. In some embodiments, inulin can be included in an amount of from about 0.1% to about 0.5% (e.g., about 0.15 to about 0.35%) by weight on a dry matter basis in a pet food composition, each. In some embodiments, a prebiotic can contain ingredients high in soluble fiber content, such as beet pulp. Ingredients high in soluble fiber, such as beet pulp, can be included in an amount of about 1% to about 8% (e.g., about 3% to about 6%) by weight on a dry matter basis in a pet food composition.

In some embodiments, a prebiotic included in a pet food composition provided herein can contribute soluble fiber in an amount of about 0.5% to about 5% (e.g., about 1% to about 5%, or about 2.5% to about 4%) by weight on a dry matter basis the pet food composition.

Although a pet food composition provided herein can include other fibers that can have prebiotic activity, as used herein, the term “prebiotic” refers to soluble fiber ingredients that are not grain derived.

A pet food composition provided herein can be formulated for any companion animal, preferably a dog or cat. Overall nutritional values, vitamin contents, mineral contents, and the like can be adjusted based on which companion animal a pet food composition is formulated for. For example, a pet food composition formulated for a dog or a cat can typically have 5% to 85% moisture (e.g., 5% to 12% for a dry food, or 75% to 85% for a wet food), 15% to 45% protein by dry weight of the food, 3% to 15% crude fiber by dry weight of the food, 6% to 10% ash, and minerals and vitamins that meet and/or exceed nutritional requirements, such as those determined by the Association of American Feed Control Officials (AAFCO), and are below maximum regulatory limits.

Other suitable ingredients can be included to achieve a desired nutrition, flavor, texture, and overall liking by the companion animal it is formulated for. Examples of suitable ingredients include, for example animal-based ingredients (e.g., deboned chicken, chicken meal, fish meal, deboned lamb, deboned beef, deboned turkey, mechanically separated salmon, mechanically separated whitefish, egg, milk ingredients, chicken fat, fish oil, chicken by-product meal, lamb meal, beef meal, turkey meal, salmon meal, and the like), vegetable ingredients (e.g., rice, barley, starches, pea protein, pea powder, carrots, coconut oil, cellulose, corn, potato, soybean ingredients, corn gluten meal, and the like), microbial ingredients (e.g., yeast extracts, fermentation products, live probiotics, and the like), enzymes, minerals, vitamins, and the like.

In some embodiments, a pet food composition provided herein can be a dry food, such as a kibble having a moisture content of less than 12% (e.g., about 5% to about 10%) by weight. A dry pet food composition can have a shelf life of at least 6 months (e.g., at least 18 months) at room temperature in suitable packaging.

In some embodiments, a pet food composition provided herein can be a wet food having a moisture content 75% to 85%. For example, a wet pet food composition provided herein can be a food in a sealed can or pouch that is stable at room temperature for at least 6 months (e.g., at least 9 months, or 18 months to 3 years) at room temperature. In another example, a wet pet food composition provided herein can be formulated to have a refrigerated or frozen shelf life of at least 1 month (e.g., about 6 weeks to about 12 months).

An example of a dog food provided herein is found in Table 1. The example in Table 1 is formulated to be a chicken flavor. It is to be understood that other ingredients can be used to achieve different flavors suitable for a dog (e.g., beef, lamb, fish, duck, and the like), and can be formulated to be a dry food or a wet food.

TABLE 1

| Ingredient | % by weight (as indicated) |
|---|---|
| Fermentate | 0.1% to 1% on a dry matter basis |
| Kelp | 0.2% to 1% on a dry matter basis |
| Prebiotic soluble fiber | 1.5% to 5% on a dry matter basis |
| Animal ingredients | 35% to 85% on an as-added basis |
| (deboned chicken, | |
| chicken meal, chicken | |
| fat, fish meal) | |
| Plant ingredients | 10% to 65% on an as-added basis |
| (brown rice, barley, | |
| cellulose, pea protein, | |
| starch) | |
| Other ingredients | 2% to 10% on an as-added basis |
| (vitamins, minerals, | |
| enzymes, etc.) | |
| Organic matter | 94% to 98% on a dry matter basis |
| Crude Fat | 6% to 25% on a dry matter basis |
| Crude protein | 18% to 45% on a dry matter basis |
| Crude Fiber | 2% to 17% on a dry matter basis |

An example of a cat food provided herein is found in Table 2. The example in Table 2 is formulated to be a chicken flavor. It is to be understood that other ingredients can be used to achieve different flavors suitable for a cat (e.g., beef, lamb, fish, duck, and the like), and can be formulated to be a dry food or a wet food

TABLE 2

| Ingredient | % by weight (as indicated) |
|---|---|
| Fermentate | 0.1% to 1% on a dry matter basis |
| Kelp | 0.2% to 1% on a dry matter basis |
| Prebiotic soluble fiber | 1.5% to 5% on a dry matter basis |
| Animal ingredients | 35% to 85% on an as-added basis |
| (deboned chicken, | |
| chicken meal, chicken | |
| fat, fish meal) | |
| Plant ingredients | 10% to 65% on an as-added basis |
| (brown rice, barley, | |
| cellulose, pea protein, | |
| starch) | |
| Other ingredients | 2% to 10% on an as-added basis |
| (vitamins, minerals, | |
| enzymes, etc.) | |
| Organic matter | 92% to 97% on a dry matter basis |
| Crude Fat | 6% to 25% on a dry matter basis |
| Crude protein | 18% to 45% on a dry matter basis |
| Crude Fiber | 2% to 17% on a dry matter basis |

It is to be understood that ingredients included in a pet food composition provided herein need not be evenly distributed throughout the pet food composition. For example, in some embodiments of a dry kibble provided herein, most or all of a fermentate and/or a prebiotic can be concentrated in some pieces of kibble, while little or none of the fermentate and/or prebiotic can be included in other pieces of kibble.

An advantage of a pet food composition provided herein is that the ingredients can be used in standard pet food making methods without losing their digestive health effects. Thus, a pet food composition provided herein can be made using any appropriate method. For example, high temperature processes, such as extrusion or retort, can be used without losing digestive health benefits.

A pet food composition provided herein can be packaged using any suitable packaging, including bags, cans, pouches, blister containers, and the like.

The following examples are provided to illustrate embodiments of the invention.

### EXAMPLES

### Example 1—Test Diets

Four dry (about 8% moisture) kibble test diets were designed for dogs and produced containing the formulations described in Table 3. The fermentate ingredient used was Culbac®, which is derived from Lactobacillus acidophilus. The amount of powdered cellulose was adjusted to accommodate the prebiotic in the diets containing prebiotic. All test diets were formulated to meet requirements set by American Association of Feed Control Officials (AAFCO) for adult maintenance. Organic matter, crude fat, crude protein, and total dietary fiber of each diet was measured using standard methods described below.

TABLE 3

| Ingredient (% | | | | | |
|---|---|---|---|---|---|
| by weight as added, | | Diet group | | | |
| unless otherwise | | | Fer- | | Prebiotics + |
| indicated) | | Control | mentate | Prebiotics | Fermentate |
| Fermentate | | — | 0.25% | — | 0.25% |
| Pre- | Kelp | — | — | 0.5% | 0.5% |
| biotic | Beet pulp | — | — | 4% | 4% |
| | FOS | — | — | 0.25% | 0.25% |
| | MOS | — | — | 0.25% | 0.25% |
| | Inulin | — | — | 0.25% | 0.25% |
| | Total | — | — | 2.5-3% | 2.5-3% |
| | prebiotic | | | | |
| | soluble fiber | | | | |

| | | | | |
|---|---|---|---|---|
| Powdered cellulose | 4% | 4% | 0.65% | 0.65% |
| Animal ingredients | 45% | 45% | 45% | 45% |
| (deboned chicken, | | | | |
| chicken meal, | | | | |
| chicken fat, | | | | |
| fish meal) | | | | |
| Plant ingredients | 47% | 47% | 47% | 47% |
| (brown rice, barley, | | | | |
| pea protein, starch) | | | | |
| Other ingredients | 3.4% | 3.4% | 3.4% | 3.4% |
| (vitamins, | | | | |
| minerals, | | | | |
| enzymes,etc.) | | | | |
| Organic matter | 94% on | 93% on | 93% on | 93% on |
| (as analyzed) | a dry | a dry | a dry | a dry |
| | matter | matter | matter | matter |
| | basis | basis | basis | basis |
| Crude Fat | 15.7% on | 15.5% on | 14.0% on | 12.8% on |
| (as analyzed) | a dry | a dry | a dry | a dry |
| | matter | matter | matter | matter |
| | basis | basis | basis | basis |
| Crude protein | 27.2% on | 27.7% on | 29.6% on | 27.2% on |
| (as analyzed) | a dry | a dry | a dry | a dry |
| | matter | matter | matter | matter |
| | basis | basis | basis | basis |
| Crude Fiber | 4.8% on | 4.2% on | 2.7% on | 3.0% on |
| (as analyzed) | a dry | a dry | a dry | a dry |
| | matter | matter | matter | matter |
| | basis | basis | basis | basis |

Twenty-four male and female adult beagle dogs (age: 5.74±2.18 years; BW: 9.30±1.32 kg) were utilized in a 168-day randomized crossover design. All animal use was first approved by the animal facility's Institutional Animal Care and Use Committee (Summit Ridge Farms; Susquehanna, PA). All dogs were deemed healthy before the study by physical exam, and exhibited normal physiologic ranges on serum chemistries before, during, and at the end of the study. All dogs were individually housed in a temperature-controlled room on a 12 h light: 12 h dark cycle. Dogs were fed once per day to maintain body weight throughout the study. Over the 5-day digestibility collections, all dogs received the same amount of food. All dogs began the study receiving the control diet for 21 days and then randomized to one of four treatment groups for the treatment period: Control, Fermentate, Prebiotics, and Prebiotics+Fermentate for 21 days. The washout and treatment periods were alternated for a total of 168 days to complete the factorial. During the treatment phase, dogs were acclimated to the diet for 14 days followed by 5 days of total fecal collections for total tract apparent nutrient digestibility (Table 7). Fecal scores were also assessed during the 5 days total fecal collection (Table 4). Body weights were taken weekly, and food intake was assessed daily (Table 7).

### Results and Discussion

Fecal short-chain fatty acid (SCFA; e.g., acetate, propionate, butyrate), branched-chain fatty acid (BCFA; e.g., isobutyrate, isovalerate, valerate), phenol, and indole concentrations were analyzed (Table 4). Surprisingly, fermentate had an effect on several fecal metabolites despite containing no live bacteria. More surprisingly, while fermentate had little to no impact on fecal BCFA, phenol, or indole content compared to control when used alone in a diet, it had a synergistic effect when combined with a prebiotic containing kelp (AOS source). See, Table 4. That is, given the effect of fermentate on fecal BCFA, phenol, and indole content over control, it would have been expected that the prebiotic+fermentate would have resembled prebiotic alone. Instead, there is an even greater directional change when fermentate and prebiotic are combined over prebiotic alone, particularly with total BCFA, phenol, and indole. This is even more unexpected since fermentate appeared to have no significant impact on the microbiome of the gut either on its own or in combination with a prebiotic containing kelp (AOS source), which might have explained changes in fecal metabolites. That is, statistical comparisons the diet groups based on weighted Unifrac distances, which is a distance metric used for comparing biological communities, showed that although prebiotic had a statistically significant impact on gut microbiome diversity, fermentate did not. See, Table 5.

TABLE 4
Fecal characteristics, short-chain fatty acid (SCFA), branched-chain fatty
acid (BCFA), phenol, and indole concentrations in adult dogs fed test diets
control, fermentate (Ferment), prebiotics, or prebiotics and fermentate.

| | Dietary treatments | | | | | |
|---|---|---|---|---|---|---|
| | | | | Prebiotics + | | |
| Item | Control | Ferment | Prebiotics | Ferment | SEM | P-Value |
| Fecal pH | 6.20^{ab} | 6.42^{a} | 5.70^{c} | 5.97^{bc} | 0.48 | 0.01 |
| Fecal Score | 3.45^{a} | 3.42^{a} | 3.31^{b} | 3.32^{b} | 0.05 | 0.01 |

Fecal metabolites, μmol/g DM

| | | | | | | |
|---|---|---|---|---|---|---|
| Acetate | 221.11^{a} | 230.75^{a} | 346.97^{b} | 371.43^{b} | 9.43 | 0.01 |
| Propionate | 135.85^{a} | 146.32^{a} | 207.14^{b} | 215.19^{b} | 9.62 | 0.01 |
| Butyrate | 42.02 | 37.43 | 31.48 | 32.21 | 2.56 | 0.05 |
| Total SCFA | 398.98^{a} | 414.50^{a} | 585.59^{b} | 618.83^{b} | 16.0 | 0.01 |
| Isobutyrate | 4.37^{a} | 4.41^{a} | 3.80^{ab} | 2.81^{b} | 0.31 | 0.01 |
| Isovalerate | 6.63^{a} | 6.83^{a} | 5.88^{ab} | 4.57^{b} | 0.45 | 0.01 |
| Valerate | 0.93^{a} | 0.89^{a} | 1.31^{b} | 1.38^{b} | 0.10 | 0.01 |
| Total BCFA | 11.93^{ab} | 12.13^{a} | 11.00^{ab} | 8.77^{b} | 0.80 | 0.03 |
| Phenol, μgram/g DM | 59.52^{a} | 63.39^{a} | 41.04^{ab} | 13.14^{b} | 8.28 | 0.01 |
| Indole, μgram/g DM | 121.50^{a} | 119.47^{a} | 69.76^{ab} | 27.08^{b} | 12.22 | 0.01 |

All values are means and pooled SEM.
^{ab}Denotes significant (P < 0.05) difference between diets.

TABLE 5

| Groups compared | R-value | p-value |
|---|---|---|
| Control, Fermentate | −0.024 | 0.843 |
| Control, Prebiotic | 0.078 | 0.026* |
| Control, Prebiotic + Fermentate | 0.078 | 0.018* |
| Fermentate, Prebiotic | 0.098 | 0.007* |
| Fermentate, Prebiotic + Fermentate | 0.1 | 0.005* |
| Prebiotic, Prebiotic + Fermentate | −0.005 | 0.469 |

*denotes statistical significance

Further, fermentate was expected to increase fecal Immunoglobulin A (IgA). Instead, fermentate appeared to have no apparent positive effect IgA in the gut (see, Table 6), and may actually blunt the IgA increase elicited by prebiotic containing kelp.

TABLE 6
Fecal qPCR for Escherichia coli and Bifidobacterium relative abundances and fecal Immunoglobulin
A (IgA) concentration of adult dogs fed test diets control, NVL, prebiotics, or prebiotics and NVL.

| | Dietary Treatments | | | | | | | | | | |
|---|---|---|---|---|---|---|---|---|---|---|---|
| | Control | | NVL | | Prebiotics | | Prebiotics + NVL | | | P-Values | |
| Item | d0 | d21 | d0 | d21 | d0 | d21 | d0 | d21 | SEM | d0 | d21 |
| Eschercia coli, Log DNA | 0.40 | 0.45^{a} | 0.45 | 0.43^{a} | 0.42 | 0.33^{b}* | 0.39 | 0.42^{a} | 0.09 | 0.73 | 0.78 |
| Bifidobacterium, Log DNA | 0.24 | 0.27 | 0.25 | 0.28 | 0.23 | 0.27 | 0.25 | 0.31 | 0.05 | 0.66 | 0.61 |
| Immunoglobulin A, mg/g DM | 37.8 | 35.4^{ab} | 32.9 | 24.8^{a} | 24.9 | 43.6^{b}* | 30.4 | 37.5^{b} | 10.9 | 0.11 | <0.01 |

All values are means and pooled SEM.
*Significant difference (P < 0.05) between d21 and d0 within diet.
^{ab}Denotes significant (P < 0.05) difference between diets on day 21. Wilcoxon Rank-Sum was used for paired analysis to determine time effects within diet. Kruskal-Wallis was used for between treatment differences at d0 and d21.

TABLE 7
Average daily food intake, body weight, and total tract apparent nutrient digestibility
in adult dogs fed control, NVL, prebiotics, and prebiotics and NVL.

| | Dietary Treatments | | | | | |
|---|---|---|---|---|---|---|
| Item | Control | NVL | Prebiotics | Prebiotics + NVL | SEM | P-Value |
| Food Intake, g/d | 266 | 237 | 256 | 267 | 10.1 | 0.10 |
| BW, kg | 9.42 | 9.33 | 9.42 | 9.26 | 0.23 | 0.37 |

Digestibility, %

| | | | | | | |
|---|---|---|---|---|---|---|
| DM | 87.2 | 87.8 | 87.5 | 86.3 | 0.45 | 0.22 |
| CP | 90.0^{a} | 90.4^{a} | 88.3^{b} | 87.2^{b} | 0.42 | 0.01 |
| Crude fat | 95.2^{a} | 95.1^{a} | 93.8^{b} | 92.9^{b} | 0.24 | 0.01 |
| Energy | 90.2^{ab} | 90.9^{a} | 90.5^{ab} | 89.3^{b} | 0.35 | 0.04 |

All values are means and pooled SEM.
^{ab}Denotes significant (P < 0.05) difference between diets.

### Materials and Methods

### Fecal Collection and Consistency Scoring

During the fecal collection phase of each period, all feces were collected, weighed, scored, and frozen at −20° C. until analyses. Fecal samples were scored three times daily over the 5-day total fecal collection according to a five-point scale where 0=none, 1=watery diarrhea, 1.5=diarrhea, 2=moist, no form, 2.5=moist, some form, 3=moist, formed, 3.5=well-formed, sticky, 4=well-formed, 4.5=hard, dry, and 5=hard, dry, crumbly. At the beginning and end of each test period, fresh fecal samples (within 15 min of defecation) were collected. Each collection was done over a 3-day period (d −1, 0, 1, 20, 21, and 22 of each test period) to ensure a sample was obtained from each dog. Collections for fecal immunoglobulin A (IgA), pH, and 16S microbiota analyses were obtained at the beginning and end of each test period, while fecal fermentative end products and DM were obtained only at the end of each test period. All fresh fecal samples were immediately measured for pH with a meter (Denver Instrument, Bohemia, NY) equipped with an electrode (Beckman Instruments Inc., Fullerton, CA). Two aliquots of fresh fecal sample were collected for fecal IgA and microbiota and stored at −70° C. until analysis. For fecal SCFA and BCFA concentrations, a fresh fecal sample was mixed with 2 N hydrochloric acid in a 1:1 (weight:weight) ratio and stored at −20° C. until analysis. Approximately 3-5 g of fresh fecal sample was collected in duplicate and stored at −20° C. until fecal phenol and indole analyses. The remaining fresh fecal sample was used for dry matter (DM) determination, where the sample was dried at 105° C. for 2 days.

### Total Tract Apparent Nutrient Digestibility

The test diets and all feces collected were analyzed according to the Association of Official Analytical Chemists (AOAC) approved analytical methodology for the following: moisture, fat, protein, fiber, ash, and calories (AOAC 930.15, AOAC 954.02, AOAC 990.03, AOAC 992.15, AOAC 991.43).

The digestibility calculations for nutrients and energy were: Total Tract Nutrient Digestibility (%)=[nutrient intake (g/d)−fecal output (g/d)]/nutrient intake (g/d)×100%.

### Fecal Fermentative End-Products

All fecal fermentation end products were analyzed as described previously (Lin et al., 2019). Briefly, fecal SCFA (acetate, propionate, and butyrate) and BCFA (valerate, isovalerate, and isobutyrate) concentrations were determined by gas chromatography according to Erwin et al. (1961). During analyses, a gas chromatograph (Hewlett-Packard 5890A series II, Palo Alto, CA) and a glass column (180 cm×4 mm i.d.) packed with 10% SP to 1200/1% H3PO4 on 80/100 mesh Chromosorb WAW (Supelco Inc., Bellefonte, PA) were used. Nitrogen was the carrier gas with a flow rate of 75 mL/min. Temperatures of the oven, detector, and injector were 125, 175, and 180° C., respectively. Fecal phenol and indole concentrations were evaluated by gas chromatography according to Flickinger et al. (2003).

DNA Extraction and Sequencing of 16S rRNA Genes

Extraction of DNA, sequencing of 16S rRNA genes, and qPCR analysis was carried out according to Pilla et al (2020). Briefly, a MoBio Power soil DNA isolation kit (MoBio Laboratories; Carlsbad, CA) was used to extract DNA from fecal samples according to manufacturer's instructions. Illumina sequencing was performed at the MR DNA laboratory (Shallowater, TX) as previously described (Minamoto et al. 2015). Briefly, the primers 515F (5′-GTGCCAGCMGCCGCGGTAA-3′) (SEQ ID NO: 1) to 806R (5′-GGACTACVSGGGTATCTAAT-3″) (SEQ ID NO: 2) on the V4 region of 16S rRNA bacterial genes were amplified. Nucleotide sequences are in Table 8. For the PCR reaction, a single-step 30 cycle PCR using the HotStarTaq Plus Master Mix Kit (Qiagen; Hilden, Germany) under the following conditions: 94° C. for 3 minutes, followed by 28 cycles (5 cycles used on PCR products) of 94° C. for 30 seconds, 53° C. for 40 seconds and 72° C. for 1 minute, after which a final elongation step at 72° C. for 5 minutes was performed. The Illumina TruSeq DNA's protocol was used to create a DNA library, and Illumina MiSeq was utilized for sequencing according the manufacturer's guidelines. Analysis of sequences was performed using QIIME 2 31 2018.8 pipeline as previously described (Marsilio et al. 2019). The amplicon sequence variant (ASV) table was created using DADA2, (Callahan et al. 2016) and rarefied to 19,200 sequences per sample based on the lowest read depth in all samples for even depth of analysis. The raw sequences were uploaded to NCBI Sequence Read Archive under accession number SRP 066795.

TABLE 8

| SEQ ID | | | | |
|---|---|---|---|---|
| NO | Type | Sequence | Name | Description |
| 1 | Nucleotide | GTGCCAGCMGCCGCGGTAA | 515F | PCR primer |
| | (DNA) | | | |
| 2 | Nucleotide | GGACTACVSGGGTATCTAAT | 806R | PCR primer |
| | (DNA) | | | |

Alpha diversity metrics were assessed by Chaol (richness), observed ASVs (species richness), and Shannon diversity (evenness). Beta diversity (diversity between samples) was evaluated with the phylogeny based weighted UniFrac distance metric and plots were visualized using Principal Coordinate Analysis (PCoA) (Lozupone et al. 2005) Analysis of similarity (ANOSIM) test within PRIMER 6 software package (PRIMER-E Ltd., Luton, UK) was used to analyze significant differences in microbial communities between time points.

### Quantitative PCR Analysis

Quantitative PCR (qPCR) assays were performed for total bacteria, Escherichia coli, Lactobacillus, and Bifidobacterium as previously described (AlShawaqfeh et al. 2017). Briefly, SYBR green-based reaction mixtures were used for qPCR reactions. The total reaction volume was 10 μl. The reaction mix consisted of the following: 5 μl SsoFast EvaGreen® supermix (Bio-Rad Laboratories, CA, USA), 0.4 μl of forward and reverse primer (final concentration: 400 nM), 2.6 μl of PCR water and 2 μl of normalized DNA (final concentration: 5 ng/μl). Conditions for PCR reaction were as follows: initial denaturation at 98° C. for 2 min, then 40 cycles with denaturation at 98° C. for 3 s and annealing for 3 s. After amplification, melt curve analysis was conducted using the following conditions: 95° C. for 1 min, 55° C. for 1 min and increasing incremental steps of 0.5° C. for 80 cycles for 5 s each. All samples were run in duplicate. Data were expressed as the log amount of DNA for each bacterial group/10 ng of isolated total DNA.

### Statistical Analysis

Between diet effects on day 21 for fecal fermentation characteristics were analyzed using Mixed models in SAS (version 9.4; SAS Institute, Cary, NC), where diet was considered a fixed effect and dog as a random effect. For within diet time effects, a paired t-test was used for normally distributed data and a Wilcoxon-Signed Rank test for non-normally distributed data. A Kruskal-Wallis was used for between diet effects for non-normally distributed data. Data are presented as mean and pooled SEM. Statistical significance was set at P≤0.05.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A pet food composition, comprising:
a. a fermentate in an amount of about 0.1% to about 1% by weight on a dry matter basis of the pet food composition, the fermentate including peptidoglycan from a non-viable, non-pathogenic gram-positive bacteria in an amount of at least 80% by dry weight of the fermentate, and
b. a prebiotic including an oligosaccharide component, the oligosaccharide component being included in an amount of about 0.5% to 2% by weight on a dry matter basis of the pet food composition, wherein the oligosaccharide component includes alginate oligosaccharide (AOS), mannan-oligosaccharides (MOS), fructooligosaccharides (FOS), or any combination thereof.

2. The pet food composition of claim 1, wherein the non-pathogenic gram-positive bacteria includes a probiotic bacteria.

3. The pet food composition of claim 2, wherein the probiotic bacteria includes Lactobacillus acidophilus.

4. The pet food composition of claim 1, wherein the fermentate is included in an amount of about 0.2% to about 0.7% by weight on a dry matter basis of the pet food composition.

5. The pet food composition of claim 1, wherein the fermentate includes from about 85% to about 95% by weight peptidoglycan from a non-viable gram-positive probiotic bacteria.

6. The pet food composition of claim 1, wherein the oligosaccharide component includes AOS, wherein at least a portion of the AOS is contributed by kelp.

7. The pet food composition of claim 6, wherein the kelp is included in an amount of about 0.2% to about 1% by weight on a dry matter basis of the pet food composition.

8. The pet food composition of claim 1, wherein the oligosaccharide component includes MOS in an amount of about 0.1% to about 0.5% by weight on a dry matter basis of the pet food composition.

9. The pet food composition of claim 1, wherein the oligosaccharide component includes FOS in an amount of about 0.1% to about 0.5% by weight on a dry matter basis of the pet food composition.

10. The pet food composition of claim 1, wherein the prebiotic includes a beet pulp in an amount of about 1% to about 8% by weight on a dry matter basis of the pet food composition.

11. The pet food composition of claim 1, wherein the prebiotic includes inulin in an amount of about 0.1% to about 0.5% by weight on a dry matter basis of the pet food composition.

12. The pet food composition of claim 1, wherein the prebiotic contributes soluble fiber in an amount of about 0.5% to about 5% by weight on a dry matter basis of the pet food composition.

13. The pet food composition of claim 1, wherein the pet food composition is a dry kibble having a moisture content of less than 12% by weight of the pet food composition.

14. The pet food composition of claim 1, wherein the pet food composition is formulated for a dog or a cat.

15. A pet food composition, comprising:
a. a fermentate in an amount of 0.2% to 0.7% by weight on a dry matter basis of the pet food composition, the fermantate including peptidoglycan from a non-viable Lactobacillus acidophilus in an amount of 85% to 95% by weight of the fermentate; and
b. a prebiotic including kelp in an amount of 0.2% to 1% by weight on a dry matter basis of the pet food composition.

16. The pet food composition of claim 15, wherein the prebiotic includes beet pulp in an amount of 1% to 8% by weight on a dry matter basis of the pet food composition.

17. The pet food composition of claim 15, wherein the prebiotic including an oligosaccharide component in an amount of about 0.5% to 2% by weight on a dry matter basis of the pet food composition, wherein the oligosaccharide component includes alginate oligosaccharide (AOS), mannan-oligosaccharides (MOS), fructooligosaccharides (FOS), or any combination thereof.

18. The pet food composition of claim 15, wherein the prebiotic includes MOS in an amount of 0.1% to 0.5% by weight on a dry matter basis of the pet food composition, FOS in an amount of 0.1% to 0.5% by weight on a dry matter basis, and inulin in an amount of 0.1% to 0.5% by weight on a dry matter basis of the pet food composition.

19. The pet food composition of claim 15, wherein the prebiotic contributes soluble fiber in an amount of about 0.5% to about 5% by weight on a dry matter basis of the pet food composition.
